(19) United States
(12) Patent Application Publication
(10) Pub. No.: US 2011/0281464 A1
(43) Pub. Date: Nov. 17, 2011

(54) ELECTRICAL CONNECTOR ASSEMBLY WITH AN ADDITIONAL REAR SHELL

(75) Inventor: LI-CHUN HOU, Kunshan (CN)

(73) Assignee: HON HAI PRECISION INDUSTRY CO., LTD., New Taipei (TW)

(21) Appl. No.: 13/105,935

(22) Filed: May 12, 2011

(30) Foreign Application Priority Data
May 12, 2010 (CN) 201020187029.2

(51) Int. Cl. H01R 13/648

(52) U.S. Cl. 439/607.55

(57) ABSTRACT

An electrical connector assembly (100) includes an insulative housing (1) with a plurality of terminal passages (12), a plurality of contacts (2) received in the corresponding terminal passages, a cable (4) electrically connected with the contacts, and a shell (5) enclosing the insulative housing. The shell comprises a top shell (52) and a bottom shell (51) assembled with each other, and a rear shell (53) behind the top shell and the bottom shell. The rear shell includes a pocket portion (531) in a rear segment thereof and a plate (532) in front of the pocket portion, the plate is arranged along a direction perpendicular to a mating direction, the plate extending into at least one of the top shell and the bottom shell to connect the rear shell with the top shell and the bottom shell.

### BACKGROUND OF THE INVENTION

1. Field of the Invention

The present invention generally relates to an electrical connector assembly, and more particularly to an electrical connector assembly used for high definition signal transmission.

2. Description of Related Art

Developed by Sony, Hitachi, Thomson (RCA), Philips, Matsushita (Panasonic), Toshiba and Silicon Image, the High-Definition Multimedia Interface (HDMI) has emerged as the connection standard for HDTV and the consumer electronics market. HDMI is the first digital interface to combine uncompressed high-definition video, multi-channel audio and intelligent format and command data in a single digital interface.

An electrical connector in accordance with HDMI standard comprises an insulative housing, a number of contacts received in the insulative housing, and a metallic shell shielding the insulative housing. U.S. Pat. No. 7,252,548 B2 issued to Huang on Aug. 7, 2007 discloses an electrical connector compatible with HDMI transmitting protocol, the electrical connector has a shielding member with a first shell and a second shell, the first shell and the second shell are assembled to each other along an up-to-down direction to enclose a electrical connection between contacts and a cable, and the first shell and the second shell are crimping and supporting the cable, however gaps may be occurred after assembly, rear segments of the first shell and the second are shielded insufficiently, and Electro-Magnetic Interference (EMI) can't be suppressed enough.

Correspondingly, it is desired to have an electrical connector assembly with improved shell to address the problems stated above.

### BRIEF SUMMARY OF THE INVENTION

Accordingly, an object of the present invention is to provide an electrical connector assembly having an additional rear shell conjoining a top shell and a bottom shell to suppress Electro-Magnetic Interference (EMI).

In order to achieve the above-mentioned object, an electrical connector assembly in accordance with the present invention comprises an insulative housing with a plurality of terminal passages, a plurality of contacts received in the corresponding terminal passages, a cable electrically connected with the contacts, and a shell enclosing the insulative housing. The shell comprises a top shell and a bottom shell assembled with each other, and a rear shell behind the top shell and the bottom shell. The rear shell includes a pocket portion in a rear segment thereof and a plate in front of the pocket portion, the plate is arranged along a direction perpendicular to a mating direction, the plate extending into at least one of the top shell and the bottom shell to connect the rear shell with the top shell and the bottom shell.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled, perspective view of an electrical connector assembly of the present invention;

FIG. 2 is an exploded, perspective view of the electrical connector assembly in the first embodiment of the present invention;

FIG. 3 is similar to FIG. 2, but viewed from another aspect;

FIG. 4 is a partially assembled, perspective view of the electrical connector assembly shown in FIG. 3;

FIG. 5 is a further assembled, perspective view of the electrical connector assembly shown in FIG. 4;

FIG. 6 is a partially assembled, perspective view of the electrical connector assembly in the second embodiment of the present invention; and

FIG. 7 is a further assembled, perspective view of the electrical connector assembly shown in FIG. 6.

### DETAILED DESCRIPTION OF THE INVENTION

Reference will now be made to the drawing figures to describe the present invention in detail.

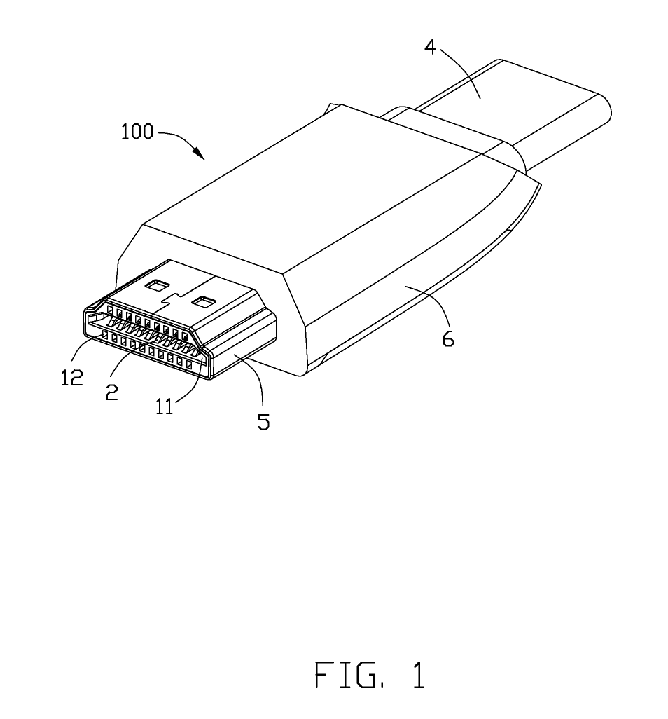

Referring to FIGS. 1-3, an electrical connector assembly 100 in accordance with the present invention comprises an insulative housing 1, a plurality of contacts 2 received in the insulative housing 1, a spacer 3 assembled to a back end of the insulative housing 1, a metallic shell 5 and a cable 4 with a plurality of wires 41.

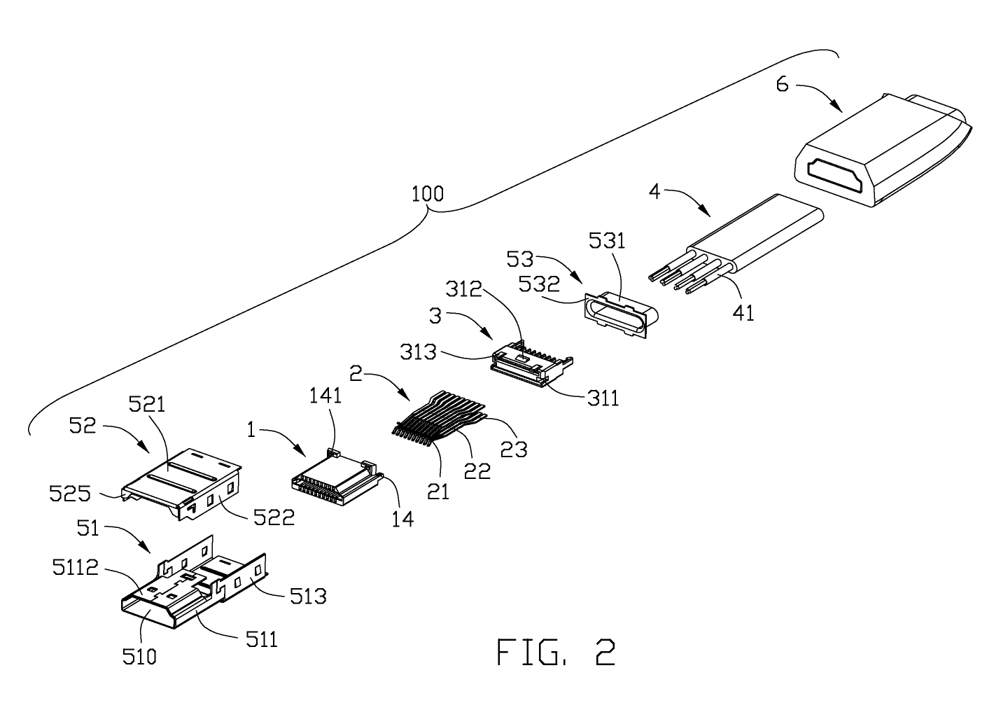

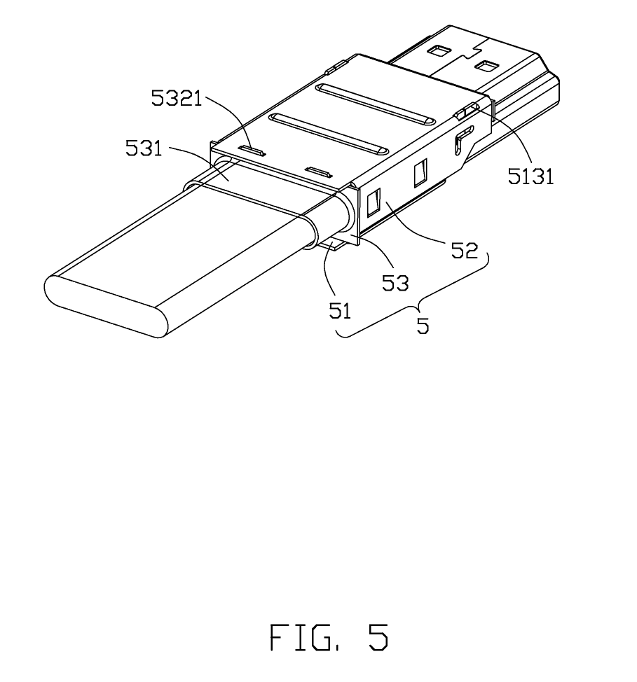

Referring to FIGS. 2-5, the insulative housing 1 comprises a trapezoid space 11 formed by four walls in the front for receiving a complementary connector (not shown), and two rows of terminal passages 12 formed in upper and bottom walls of the insulative housing 1 and communicate with the trapezoid space 11 to receive the contacts 2. A connecting face 15 is defined on a back end of the insulative housing 1, and a pair of positioning legs 13 are extending rearwards from the connecting face 15 along a mating direction. The insulative housing 1 defines a pair of stopping portions 14 located on a top surface thereof, and the stopping portions 14 are protruding forwards and upwards from the connecting face 15. Each stopping portion 14 defines an engaging hole 141 through thereof along the mating direction.

The contacts 2 are inserted into the terminal passages 12 from the rear end of the insulative housing 1 along the mating direction, with elastic contact portions 21 in the front of the contacts 2 inserted into the trapezoid space 11, and tail portions 23 exposed beyond the connecting face 15 of the insulative housing 1 to connect with the wires 41. A plurality of barbs 221 are formed on retaining portions 22 in the middle of the contacts 2 to hold the contacts 2 in the insulative housing 1.

The spacer 3 includes a main portion 31 in the front thereof and a sustaining portion 32 extending rearwards from the main portion 31. The main portion 31 defines a pair of coupling slots 311 depressed from a front surface thereof. A central locking tab 312 is arranged on a top surface of the main portion 31, and a pair of ribs 313 are defined on both sides of the locking tab 312, the ribs 313 are extending upwards and forwards from the top surface of the main portion 31, then extruding beyond a front end surface of the main portion. The sustaining portion 32 defines a plurality of grooves 321 receiving the contacts 2 and extending forwards through the main portion 31.

The cable 4 is of flat shape in cross-section substantially in the preferred embodiment of present invention, and has the plurality of wires 41. In other selectable embodiment, the cable 4 can be of round shape or other shapes.

The shell 5 is made of metallic material and comprises a top shell 52, a bottom shell 51 assembled to the top shell 52 along a direction perpendicular to the mating direction, and a rear shell 53 conjoining the top shell 52 and the bottom shell 51. The bottom shell 51 comprises a frame-shaped base portion 511 and an extension portion 513 extending backwards from the base portion 511. The base portion 511 has a trapezoidal cavity 510 and a top wall 5112 above the cavity 510, the top wall 5112 is extending backwards to form a latching portion 5113, and a latching hole 5114 is arranged in the latching portion 5113. The extension portion 513 has a pair of projections 5131 extending upwards on both sides thereof, and a plurality of extrusions 5132 are disposed on lateral sides of the extension portion 513. A pair of slits 5133 are defined in a rear end of the extension portion 513.

The top shell 52 comprises an upper wall 521 and a pair of lateral walls 522 bent downwards from the upper wall 521, a receiving hole 523 is arranged in a connecting area between the upper wall 521 and each lateral wall 522. Each lateral wall 522 defines a number of through holes 524, and a pair of obstructions 525 are bent downwards from a front end of the upper wall 521. The upper wall 521 has a pair of notches 526 on a rear end thereof.

The rear shell 53 comprises a pocket portion 531 in a rear segment thereof and a plate 532 in front of the pocket portion 531, and the plate 532 is arranged along a direction perpendicular to the mating direction. The pocket portion 531 is of a close configuration formed by four conjoint walls, and the rear shell 53 defines a hollow 530 therethrough, the hollow 530 and the cable 4 have the same shape as each other in a cross-section, and the shape of the hollow 530 is defined as the shape of the cable 4. The plate 532 is of rectangular shape and symmetrical up and down, a pair of protrusions 5321 are defined on each of the upper side and the lower side, and the protrusions 5321 are extending outwards along a vertical direction.

Referring to FIGS. 2-5, in assembly, the contacts 2 are inserted into the terminal passages 12 of the insulative housing 1 from back-to-front, and the contacting portions 21 are exposed in the trapezoid space 11 of the insulative housing 1. The spacer 3 is assembled to the insulative housing 1 along the rear-to-front direction and adjacent to the connecting face 15 of the insulative housing 1. The tail portions 23 of the contacts 2 are extending through the main portion 31 of the spacer 3, and then received in the grooves 321. The positioning legs 13 on both sides of the insulative housing 1 are accommodated in the coupling slots 311 of the spacer 3. The tabs 313 of the spacer 3 are inserted into the corresponding engaging holes 141 of the insulative housing 1.

Then the cable 4 is inserted through the hollow 530 of the rear shell 53 and received in the pocket portion 531, the wires 41 are soldered to the tail portions 23 of the contacts 2 to form an electrical connection. The aforementioned elements are disposed into the bottom shell 51 along the rear-to-front direction, the base portion 511 is enclosing the insulative housing 1, and the locking tab 312 is latched in the latching hole 5114 of the latching portion 5113. The rear shell 53 is moving forwards until the protrusions 5321 on lower side thereof inserted into the slits 5133 of the bottom shell 51. Then the top shell 52 is assembled to the extension portion 513 of the bottom shell 51 and the rear shell 53 along an up-to-down direction, the obstructions 525 of the top shell 52 are located in front of the corresponding stopping portions 14 of the insulative housing 1, and the projections 5131 of the bottom shell 51 are inserted into the receiving holes 523 of the top shell 52, the extrusions 5132 are retained in the through holes 524. The protrusions 5321 on upper side of the rear shell 53 are inserted into the notches 526 of the top shell 52, therefore the rear shell 53 is connected with the top shell 52 and the bottom shell 51 via the two pairs of protrusions 5321. After that, the protrusions 5321 are soldered in the corresponding slits 5133 and notches 526, the projections 5131 are soldered in the receiving holes 523 of the top shell 52, to enhance conjunction intensity therebetween.

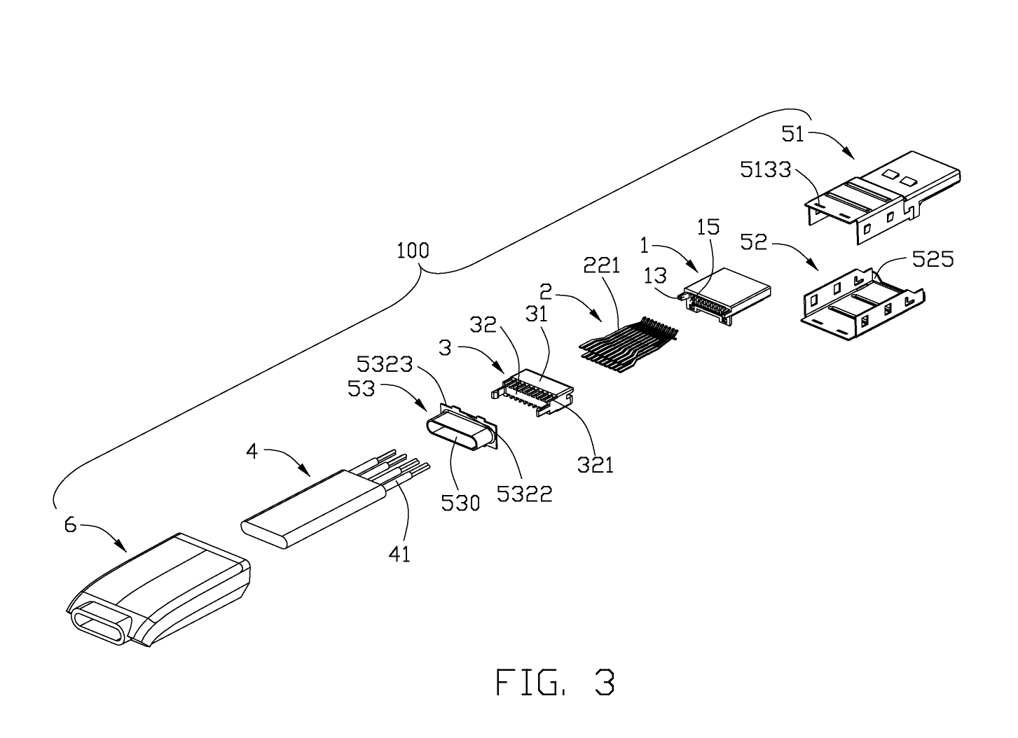

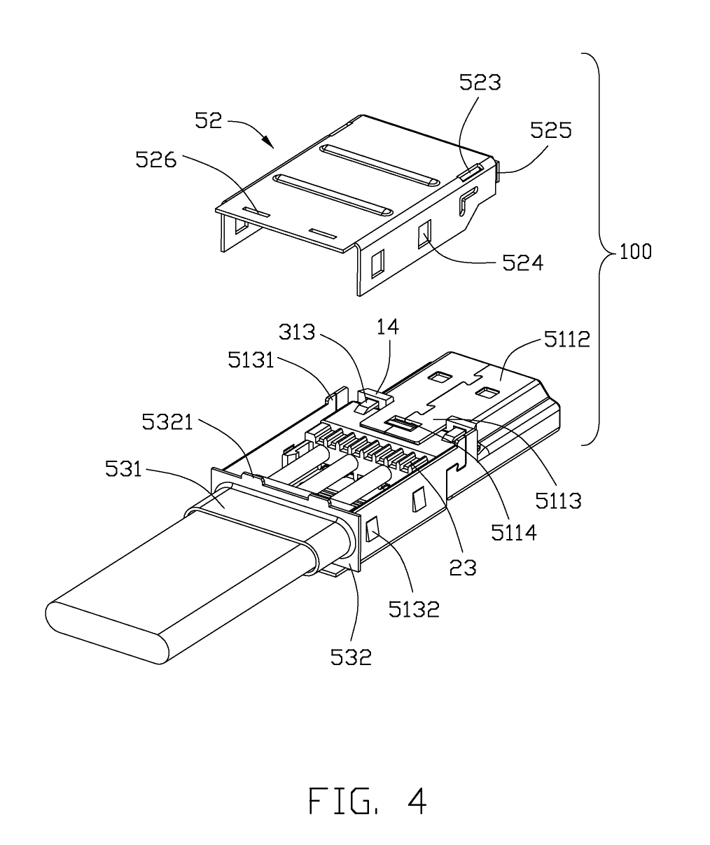

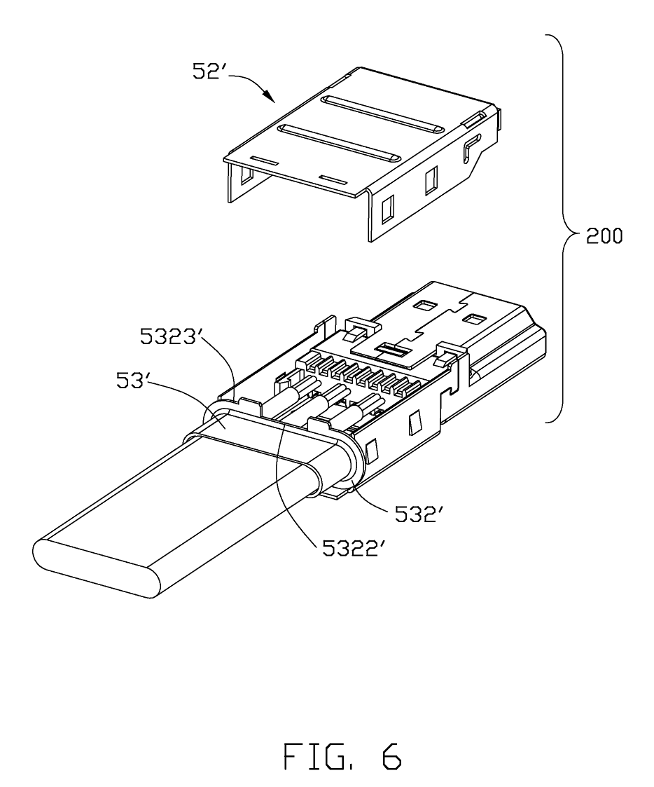

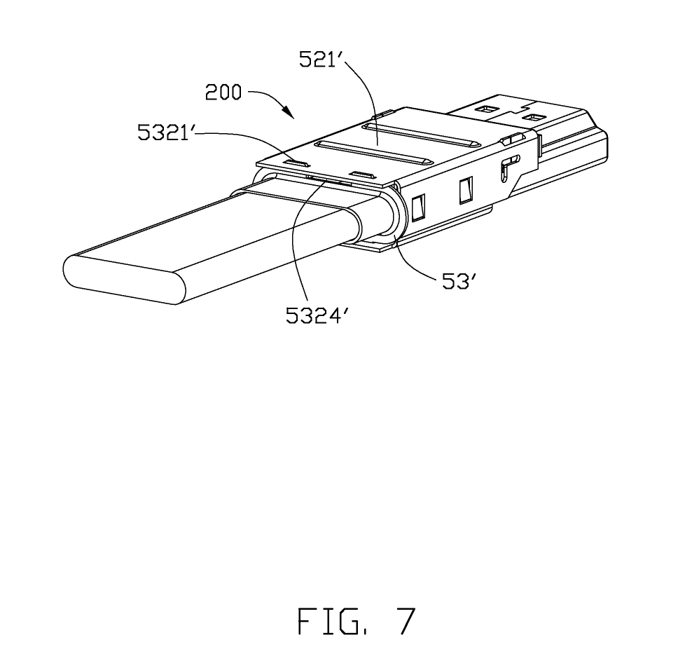

In the first embodiment of the present invention (shown in FIGS. 3-4), a first plane 5322 is sandwiched between the pair of protrusions 5321 on a same side of the plate 532, a pair of second planes 5323 are defined outside the pair of protrusions 5321 on the same side, the first plane 5322 and the second plane 5323 are located on a same level, and adjacent to the top shell 52 and the bottom shell 53. In a second embodiment of the present invention (shown in FIGS. 6-7), an electrical connector assembly 200 approximately has a same configuration with the electrical connector assembly 100 in the first embodiment, and only a plate 532′ of a rear shell 53′ of the electrical connector assembly 200 is different from the electrical connector assembly 100. The plate 532′ is of ringed runway shape, a first plane 5322′ sandwiched between a pair of protrusions 5321′ has different levels with a second plane 5323′, so a cutlet 5324′ is formed between an upper wall 521′ of a top shell 52′ and the first plane 5322′ after the rear shell 53′ assembled to the top shell 52′.

In the first embodiment of the present invention, an inner cover is molded on an electrical connection between the contacts and the cable before the shell 5 assembled. In the second embodiment of the present invention, the cover 6 is over-molded on the shell 5 directly, melted material of the cover 6 can flow into the shell 5 from the cutout 5324′ and enclose the electrical connection, therefore an inner cover can be omit. After the cover 6 over-molded on the shell 5, the electrical connector assembly 100 is assembled.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly, comprising:
an insulative housing with a plurality of terminal passages;
a plurality of contacts received in the corresponding terminal passages;
a cable electrically connected with the contacts; and
a shell enclosing the insulative housing, and having a top shell and a bottom shell assembled with each other;
wherein the shell further comprises a rear shell behind the top shell and the bottom shell, and the rear shell includes a pocket portion in a rear segment thereof and a plate in front of the pocket portion, the plate is arranged along a direction angled to a mating direction, the plate extending into at least one of the top shell and the bottom shell to connect the rear shell with the top shell and the bottom shell.

2. The electrical connector assembly as claimed in claim 1, wherein said plate is arranged in the direction perpendicular to the mating direction.

3. The electrical connector assembly as claimed in claim 2, wherein the plate defines at least one protrusion on each of an upper side and a lower side, and the protrusions are extending outwards along a vertical direction.

4. The electrical connector assembly as claimed in claim 3, wherein at least one of the top shell and the bottom shell has a slit in a back section thereof, and the protrusion is received and soldered in the slit.

5. The electrical connector assembly as claimed in claim 3, wherein the pocket portion is of a close configuration formed by four conjoint walls.

6. The electrical connector assembly as claimed in claim 5, wherein the rear shell defines a hollow therethrough along a back-to-front direction, the hollow and the cable have a same shape as each other in a cross-section.

7. The electrical connector assembly as claimed in claim 2, wherein the plate defines a pair of protrusions on each of an upper side and a lower side, and a first plane is sandwiched between the pair of protrusions on a same side of the plate, a pair of second planes are defined outside the pair of protrusions on the same side, the second planes are located on a same level.

8. The electrical connector assembly as claimed in claim 7, wherein the plate is symmetrical up and down.

9. The electrical connector assembly as claimed in claim 8, wherein the top shell has an upper wall, and the first plane and the second planes are located on the same level and adjacent to the upper wall of the top shell.

10. The electrical connector assembly as claimed in claim 8, wherein the top shell has an upper wall, and a cutlet is formed between the upper wall and the first plane after the rear shell assembled to the top shell.

11. The electrical connector assembly as claimed in claim 7, wherein the plate is of ringed runway shape.

12. The electrical connector assembly as claimed in claim 2, wherein the insulative housing has a pair of stopping portions located on a top surface thereof, and the stopping portions are protruding forwards and upwards from a connecting face, each stopping portion defines an engaging hole through thereof along the mating direction.

13. The electrical connector assembly as claimed in claim 12, wherein a spacer is assembled to the insulative housing and has a pair of ribs extending upwards and forwards from a top surface of the spacer, the ribs are extruding beyond a front end surface of the spacer and inserted into the corresponding engaging holes.

14. The electrical connector assembly as claimed in claim 13, wherein the spacer also defines a locking tab sandwiched between the pair of ribs, the bottom shell has a latching portion with a latching hole therein, and the locking tab is accommodated in the latching hole.

15. An electrical connector assembly comprising:
an insulative housing defining a plurality of passageways extending along a front-to-back direction and communicating with a front mating port thereof;
a plurality of contacts disposed in the housing with front contacting sections exposed in the front mating port, and rear connecting sections along said front-to-back direction;
a cable located behind the housing and including a plurality of wires connecting to the rear connecting sections of the corresponding contacts, respectively;
a metallic shell enclosing the housing and including first and second halves assembled to each other in a vertical direction perpendicular to said front-to-back direction; and
said shell further including rear part configured with a tubular structure to have said cable snugly extend therethrough; wherein
said rear part includes a flange section extending laterally from a front edge of the tubular structure to lock to at least one of said first and second halves.

16. The electrical connector assembly as claimed in claim 15, wherein said flange section cooperates with the cable to forwardly shield an interior defined by the first and second halves.

17. The electrical connector assembly as claimed in claim 16, further
including an insulative spacer behind the housing in the interior to regulate either the connecting sections or the wires.

18. The electrical connector assembly as claimed in claim 15, wherein the wires are side by side along a transverse direction, which is perpendicular to both said front-to-back direction and said vertical direction, unified with one another via a jacket of the cable.

19. The electrical connector assembly as claimed in claim 15, wherein both the first and second halves extend rearwardly behind the flange section.

20. The electrical connector assembly as claimed in claim 15, wherein said flange section extends in both the vertical direction and the transverse direction.
